(19) United States
(12) Patent Application Publication
(10) Pub. No.: US 2007/0047417 A1
(43) Pub. Date: Mar. 1, 2007

(54) SYSTEM AND METHOD FOR OPTIMIZING WRITE STRATEGY PARAMETERS BY ADOPTING DIFFERENT ADJUSTMENT PROCEDURES ACCORDING TO QUALITY INDICES

(75) Inventors: Chih-Hsiung Chu, Hsinchu County (TW); Jin-Chuan Hsu, Hsinchu County (TW); Po Wei Chang, Hsinchu County (TW); Yi-jiun Lai, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/462,076

(22) Filed: Aug. 3, 2006

Related U.S. Application Data
(60) Provisional application No. 60/712,931, filed on Aug. 31, 2005.

(51) Int. Cl. G11B 7/0045

(52) U.S. Cl. 369/59.12

(57) ABSTRACT

A method for optimizing write strategy parameters by adopting different adjustment procedures according to quality indices is provided. A quality index representing a reproduction result corresponding to a write strategy is acquired. One adjustment procedure is determined from multiple adjustment procedures according to the acquired quality index. The determined adjustment procedure is performed to optimize the write strategy. The write strategy comprises multiple write strategy parameters. Each adjustment procedure comprises at least one of the write strategy parameters to be adjusted and the sequence of the adjusted write strategy parameters.

### CROSS-REFERENCE TO RELATED APPLICATIONS

The present application claims the benefit of U.S. patent application entitled “A METHOD AND APPARATUS FOR OPTIMIZING WRITING PARAMETERS”, Ser. No. 60/712,931, filed Aug. 31, 2005.

### BACKGROUND

The invention relates to optical storage medium recording, and more particularly, to systems and methods for optimizing write strategy parameters by adopting different adjustment procedures according to quality indices.

As requirements for digital storage and multimedia applications are increasing, optical storage devices such as digital video disk (DVD) recorders become standard devices been installed in personal computers. Manufactures produce various types of optical disks for each optical storage format. In order to obtain optimized writing characteristics and widely support various disks, optical storage device manufactures typically prepare optimized write strategies for various types of optical disks and store these write strategies with relevant disc identification codes in memory devices of optical storage devices, thus, consumers can accordingly obtain good quality in recording.

New types of optical disks, however, are continually produced. Excessive memory space and expensive cost are required to support all types of optical disks, and alternately, deficient support of all types of optical disks will limit the practicality of the optical storage devices. Consumers may connect to Internet and download the newest firmware programs for optical storage devices from manufacture Websites, but that results in decreasing convenience. In addition, some optical storage devices such as DVD recorders can not connect to Internet to obtain the newest firmware programs. Certain solutions disclosed in published patents may first perform several trial recordings respectively using several pre-established write strategies and subsequently determine a better write strategy or a combination of write strategies therefrom according to several write quality indices. However, the recording quality is restricted by the pre-established write strategies.

Different optical disk manufacturers may produce various types of optical disks containing the same disc identification code, thus, optical storage devices will accordingly record data using the same write strategy on various types of optical disks, resulting in recording characteristic biases. It maybe a reason that a manufacturer writes the same disc identification code in optical disks manufactured in different time periods, though manufacturing processes are changed in different time periods to produce them. Thus, it is unreliable to select proper write strategies according to disc identification codes. In order to overcome the described problem, optical storage devices may further compare pre-recorded information such as write strategy, write power and others to ensure the accuracy of the write strategy after recognizing the disc identification code. The drawbacks are that excessive storage capacity to store corresponding information is consumed and limited types of optical discs could support.

Furthermore, optical storage devices may perform the conventional optimal power calibration (OPC) procedure by using a pre-established write strategy to obtain an optimized write laser power. That always has manufacturing difference between the optical disks or the optical disk recorders, so the acquired optimal write strategy for recording the patterns may be diverged from the best setting, and recorded patterns may be degrade because the write quality is not reliable.

### SUMMARY

Methods for optimizing write strategy parameters by adopting different adjustment procedures according to quality indices are provided. An embodiment of a method comprises the following steps: acquiring a quality index representing a reproduction result which is a write strategy; determining one adjustment procedure from a plurality of adjustment procedures according to the acquired quality index; and performing the determined adjustment procedure to optimize the write strategy.

Systems for optimizing write strategy parameters by adopting different adjustment procedures are provided. An embodiment of a system comprises a signal read unit; a write parameter adjustment unit for acquiring at least one reproduced quality index corresponding to a write strategy from the signal read unit, determining one adjustment procedure according to the reproduced quality index to optimize the write strategy; and a pattern write unit for outputting the write strategy from the write parameter adjustment unit.

The write strategy comprises a plurality of write strategy parameters. Each adjustment procedure comprises at least one of the write strategy parameters to be adjusted and the sequence of the adjusted write strategy parameters.

### BRIEF DESCRIPTION OF THE DRAWINGS

The invention will become more fully understood by referring to the following detailed description of embodiments with reference to the accompanying drawings, wherein:

FIG. 1a is a diagram of an exemplary “castle-type” laser output;

FIG. 1b is a diagram of an exemplary “multi-pulse” laser output;

FIG. 2 is a diagram of a hardware environment applicable to an embodiment of a system for optimizing write strategy parameters;

FIG. 3 is a flowchart illustrating an embodiment of a method for optimizing write strategy parameters by adopting different adjustment procedures according to quality indices;

FIG. 4 is a flowchart illustrating an embodiment of a method for preparing initial write strategy parameters;

FIG. 5 is a flowchart illustrating a first embodiment of a method for adjusting dynamic write strategy parameters;

FIG. 6 is a flowchart illustrating a second embodiment of a method for adjusting dynamic write strategy parameters;

FIG. 7 is a flowchart illustrating an embodiment of a method of full adjustment for all write strategy parameters;

FIG. 8 is a flowchart illustrating an embodiment for obtaining an optimized value using one-dimensional search.

### DESCRIPTION

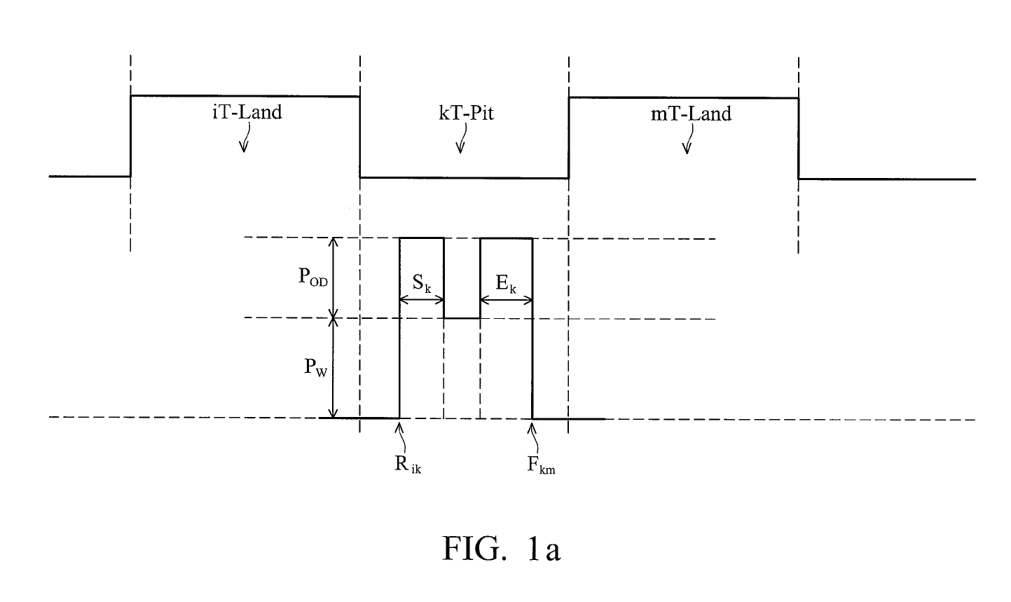

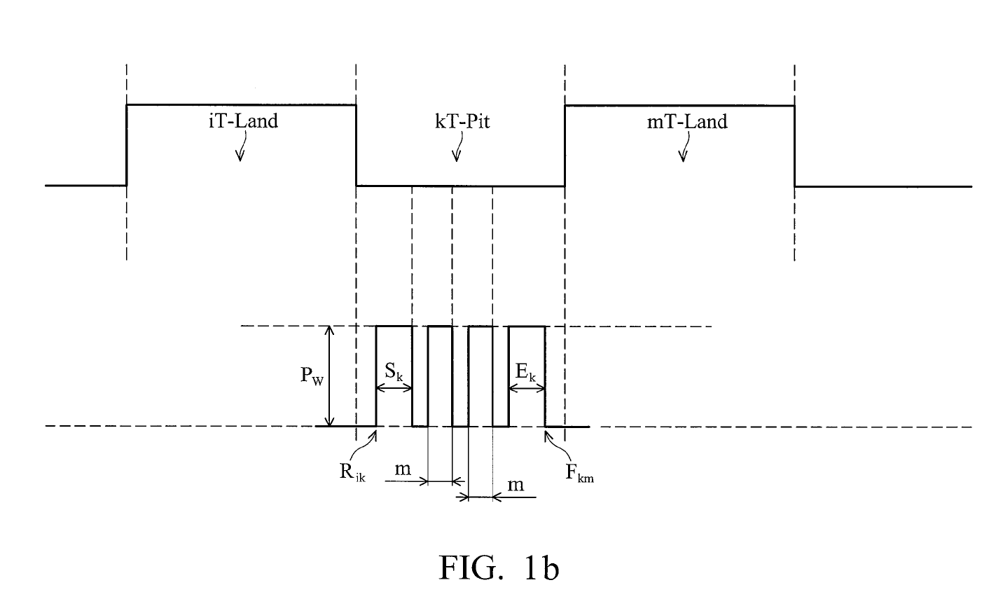

The present invention could be adopted for optimizing two kinds of write strategies. FIGS. 1a and 1b are diagrams of exemplary write strategies for recording pits, respectively an exemplary “castle type” write strategy and an exemplary “multipulse type” write strategy. Referring to FIG. 1a, P_{w} represents laser power level, OD (over drive) represents overdrive power percentage for short patterns, Sₖ and Eₖ respectively represent OD power width of the front end of the short patterns and OD power width of the hack end of the short patterns. Short patterns may contain 3T to 5T patterns. In the other embodiment, P_{w}, OD, Sₖ, and Eₖ can also use in recording long pattern for 5T to 11T, 14T. In this embodiment, write strategy parameters P_{w}, OD, Sₖ and Eₖ are referred as static write strategy parameters. The static write strategy parameters associates with whether patterns are formed and their formation quality. Besides, Rᵢₖ and Fₖₘ are referred as dynamic write strategy parameters , where ik and km represent combinations of previous(i) and following(m) T-length patterns respectively, the T-lengths are as 3T to 6T or greater. Rᵢₖ means the rising timing of the write pulse of the current kT pattern regarding to the previous iT pattern. Fₖₘ means the falling timing of the write pulse of the current kT pattern regarding to the following mT pattern. It means that the dynamic write strategy parameters are affected by combinations of previous and following T-length patterns. By adjusting Rᵢₖ and Fₖₘ, the heat interference between the adjacent patterns is overcome to form more precise patterns. Referring to FIG. 1b, in multipulse write strategy, P_{w} represents laser power level, Sₖ and Eₖ respectively represent widths of a start pulse and an end pulse, m represents a ratio of width of one middle pulse to base clock T. P_{w}, m, Sₖ and Eₖ are referred as static write strategy parameters and Rᵢₖ and Fₖₘ are referred as dynamic write strategy parameters.

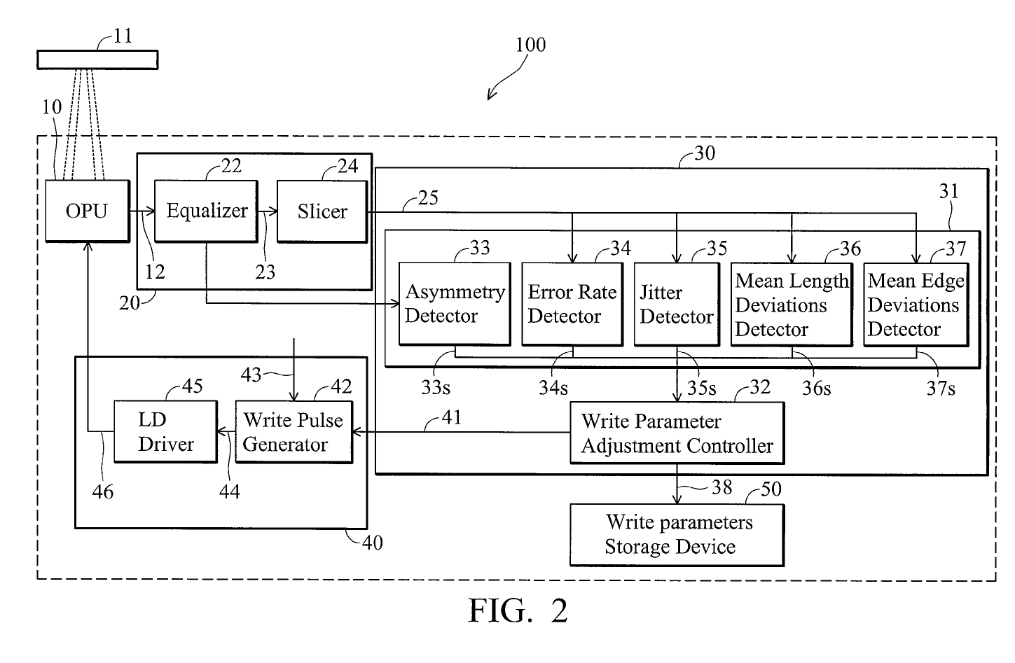

FIG. 2 is a diagram of a hardware environment applicable to an embodiment of a system for optimizing write strategy parameters. An embodiment of an optical disk recorder 100 comprises an optical pick-up (OPU) 10, a signal read unit 20, a write parameter adjustment unit 30 and a pattern write unit 40. The signal read unit 20 comprises a waveform equalizer 22 and a slicer 24, being part of a read channel of the optical storage apparatus 100. In the another embodiment, the slicer can be replaced by an edge detector. The OPU 10 reads data patterns from an optical disk 11 and generates radio frequency (RF) signals 12. The waveform equalizer 22 rebuilds RF signals 12 to equalized signals 23. The equalized signals 23 are divided into sliced signals 25 by the slicer 24 (or the edge detector). The equalized signals 23 and the sliced signals 25 are input signals of the write parameter adjustment unit 30.

Write parameter adjustment unit 30 comprises two devices: a write quality detection unit 31 and a write parameter adjustment controller 32. The write quality detection unit 31 comprises an asymmetry detector 33, an error rate detector 34, a jitter detector 35, a length deviation detector 36 and an edge deviation detector 37. The equalized signals 23 are input to the asymmetry detector 33. The sliced signals 25 are input to the error rate detector 34, the jitter detector 35, the length deviation detector 36 and the edge deviation detector 37. After calculating the input signals, the asymmetry detector 33 outputs an asymmetry of RF signal 33s (also called β value), the error rate detector 34 outputs a data error rates 34s, the jitter detector 35 outputs a jitter magnitudes 35s, the length deviation detector 36 outputs a mean length deviations for all pattern combinations 36s, and the edge deviation detector 37 outputs a mean edge shift deviation for all pattern combinations 37s.

RF signal asymmetry 33s, data error rates 34s, jitter magnitudes 35s, mean length deviations for all pattern combinations 36s, and mean edge shift deviations for all pattern combinations 37s are selectively input to the write parameter adjustment controller 32 according to operations during write parameter adjustment processes. For example, when determining whether write quality is acceptable, the data rates 34s and jitter magnitudes 35s are input to the write parameter adjustment controller 32 as input signals. When adjusting dynamic write strategy parameters, mean length deviations for all pattern combinations 36s, and mean edge shift deviations for all pattern combinations 37s are input to the write parameter adjustment controller 32 as input signals. Note that although the present invention adopts one or more combinations of the above input signals, it is unnecessary to reference all input signals during write parameters optimization. Furthermore, those skilled may adopt different but similar input signals representing write quality to perform write parameter adjustment. Output signals of the write parameter adjustment controller 32 act as write pulse control signals 41 controlling shape of the write pulse and the write strategy parameters 38. The write strategy parameters 38 are further stored in a write parameters storage unit 50.

The write parameter adjustment controller 32, in normal write strategy parameter adjustment, sets certain candidate write strategy parameters and acquires the best settings of write strategy parameters by a series of previous test writes. The write parameter adjustment controller 32, in dynamic write strategy parameter adjustment, calculates corrections for dynamic write strategy parameters according to physically measured mean length deviations and mean edge shift deviations for all pattern combinations and adjusts dynamic write strategy parameters according to the calculated corrections. Thereafter, the write parameter adjustment controller 32 issues control signals 41 to a write pulse generator 42. Details of write parameter adjustment process will be further described in the following flowcharts.

The pattern write unit 40 comprises the write pulse generator 42 and a laser diode (LD) driver 45, being part of a write channel of the optical storage apparatus 100. The control signals 41 and modulated signals 43 are input in the write pulse generator 42, where the modulated signals 43 may be signals modulated from original encoded data, or particular pattern signals. The write pulse generator 42 generates relevant write pulses 44 according to the control signals 41 and the modulated signals 43, and subsequently the LD driver 45 generates corresponding driving signals 46 to direct the OPU 10 to perform pattern writes.

The write parameters storage unit 50 records write parameters whose write quality satisfying predetermined specification after learning. The write parameter storage unit 50 may be an EEPROM, a FLASH-ROM or similar.

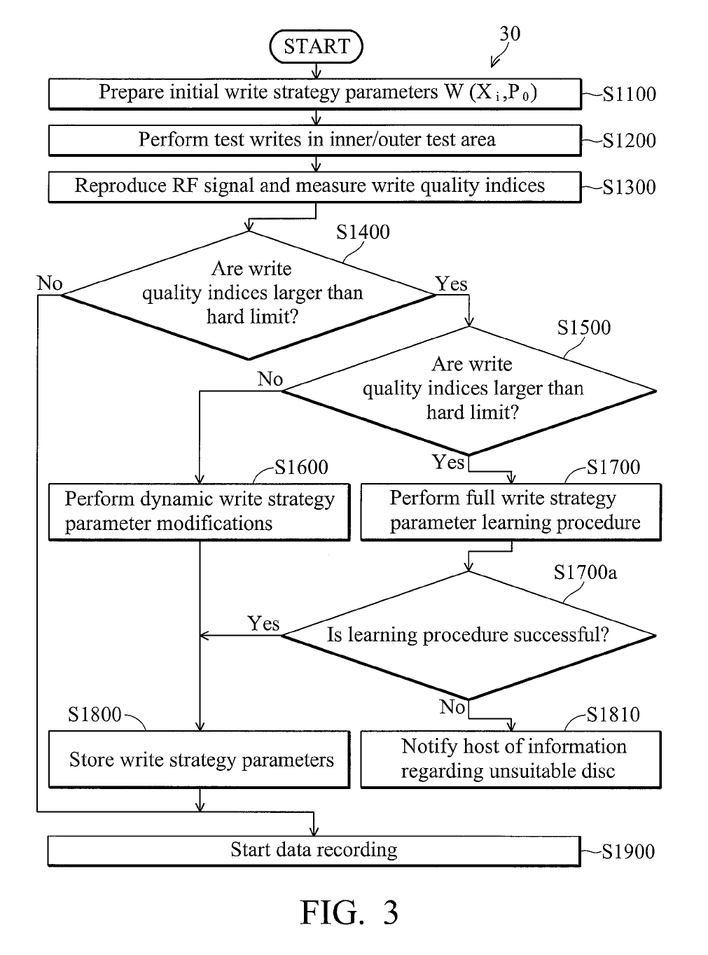

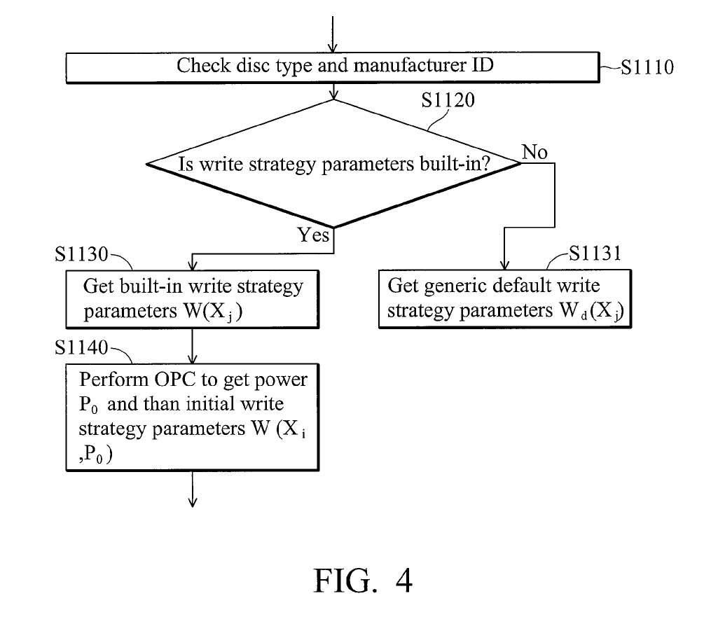

FIG. 3 is a flowchart illustrating an embodiment of a method for optimizing write strategy parameters by adopting different adjustment procedures according to quality indices, performed by the write parameter adjustment controller 32 (as shown in FIG. 2). Note that, when a castle type write strategy is used, the static write strategy parameters include P_{w}, OD, Sₖ and Eₖ, and when a multi-pulse write strategy is used, the static write strategy parameters include P_{w}, m, Sₖ and Eₖ. In step S1100, initial write strategy parameters W(Xⱼ, P₀) are prepared, where write strategy parameters Xⱼ includes OD/m, Sₖ, Eₖ, Rᵢₖ and Fₖₘ. Details of step S1100 will be further described in FIG. 4. FIG. 4 is a flowchart illustrating an embodiment of a method for preparing initial write strategy parameters performed in step S1100 (FIG. 3). In step S1110, a disk type and a manufacturer identity (ID) of the loaded disk 11 (FIG. 2) are checked. Information regarding a disk type such as CD, DVD-R, DVD+R, DVD-RW, SACD, and a manufacturer ID are acquired on the optical disk 11. In step S1120, it determines whether the loaded optical disk 11 is supported, namely, determines whether the optical disk recorder 100 has a built-in write strategy corresponding to the optical disk 11. If the current medium is supported with a built-in write strategy, the process proceeds to step S1130, otherwise, to step S1131. In step S1130, the built-in write strategy parameters Wₘ(Xⱼ) associated with the acquired disk type and manufacturer ID are acquired, m means the built-in manufacturer ID and Xⱼ means one of the write strategy parameters as shown in FIGS. 1a and 1b. In step S1131, default generic write strategy parameters W_{d}(Xⱼ) are acquired as initial write strategy parameters. In step S1140, a well-known optimal power calibration (OPC) for the acquired write strategy parameters is performed to acquire an initial write power P₀ and further acquire a candidate set (i.e. initial set) of write strategy parameters W(Xⱼ, P₀).

Referring back to FIG. 3, step S1200 is a write quality test step performing test writes in inner or outer test area of the loaded optical disk 11. In step S1300, radio frequency (RF) signals of the previous test writes are reproduced, and write quality indices for the previous test writes are accordingly measured. The write quality indices may be outputs of one or more write quality detection units, such as RF signal asymmetry 33s, data error rates 34s, jitter magnitudes 35s, mean length deviations for all pattern combinations 36s, and mean edge shift deviations for all pattern combinations 37s.

In step S1400, it determines whether the measured write quality indices are larger than hard limits (i.e. dissatisfies hard limits). If so, the process proceeds to step S1500, otherwise, to step S1900. The measured write quality indices (generated by step S1300) satisfying hard limits means that current write strategy parameters thereto are proper for the optical disk recorder 100 and the loaded optical disk 11 and require no further adjustment, thus, the process directly proceeds to step S1900 to start subsequent real data recording. The measured write quality indices (generated by step S1300) dissatisfying hard limits means that current write strategy parameters thereto are not completely proper and require a further verification by step S1500 to determine whether the measured write quality indices satisfy soft limits.

In step S1500, it determines whether the measured write quality indices are larger than soft limits (i.e. dissatisfies soft limits). If so, the process proceeds to step S1700, otherwise, to step S1600. The measured write quality indices (generated by step S1300) satisfying soft limits means that these improper write qualities may be caused by the differences of optical disk recorders, and current write strategy parameters thereto require slight adjustment (i.e. adjusting dynamic write strategy parameters Rᵢₖ and Fₖₘ) for the optical disk recorder 100 and the loaded optical disk 11. The measured write quality indices (generated by step S1300) dissatisfying soft limits means that write qualities highly deviate from the target and current write strategy parameters thereto require a full write strategy adjustment, then the process proceeds to step S1700.

Step S1400 for verifying hard limits may not be prior to S1500 for verifying soft limits. Steps S1400 and S1500 may be integrated into a single step. The objects of separation of steps S1400 and S1500 are to divide the measured write quality indices into certain categories such as requiring no adjustment (i.e. write quality is good), requiring slightly tuning (i.e. write quality can be effectively improved), requiring resetting (i.e. write quality is bad) or similar. Proper division of measured quality indices can reduce process steps and time for optimizing write strategy parameters.

After performing step S1600 slightly tuning Rᵢₖ and Fₖₘ, the process proceeds to S1800 to store current write strategy parameters, facilitating initiation of write strategy parameters for other optical disks of the same kind. After performing step S1700 completely adjusting write strategy parameters, the process proceeds to S1700a for further verification. If write quality indices satisfy predetermined target, the process proceeds to step S1800 to store current write strategy parameters, otherwise, to step S1810 to transmit current write quality indices to a host via an interface such as Integrated Device Electronics (IDE), Serial ATA (SATA) or Universal Serial Bus (USB), thereby the host will make a decision. The step S1700a for verifying adjustment results may be integrated into step S1700 for completely adjusting write strategy parameters, resulting in requiring no additional test writes. That is to say, when obtaining relevant write quality or performance indices via step S1700, step S1700 can determine whether step S1800 or S1810 is subsequently performed.

Step S1800 stores the adjusted write strategy parameters. It may store the adjusted write strategy parameters in a memory device of the optical disk recorder 100, such as Electrically Erasable Programmable Read-Only Memory (EEPROM) or flash ROM, alternately, it may transmit the adjusted write strategy parameters via an interface, such as IDE, SATA or USB, with the acquired manufacturer ID to a host, thereby enabling the host to store that in a storage device thereof.

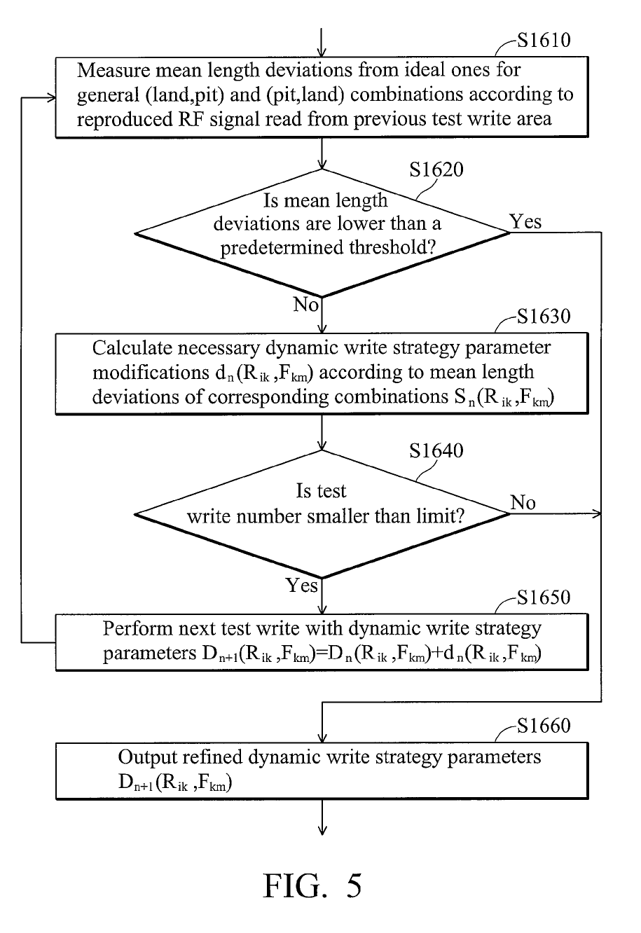

FIG. 5 is a flowchart illustrating a first embodiment of a method for adjusting dynamic write strategy parameters, performed in step S1600 of FIG. 3. In step 1610, mean length deviations from ideal ones for general (land,pit) and (pit,land) combinations are measured according to reproduced RF signals read from previous test write area. In step S1620, it determines whether the measured mean length deviations are smaller than a predetermined threshold. If so (i.e. the measured mean length deviation is acceptable), the process proceeds to step S1660, and otherwise, to step S1630. In step S1660, refined dynamic write strategy parameters Dₙ₊₁(Rᵢₖ, Fₖₘ) are output.

Dynamic write strategy parameter modifications of corresponding combinations (Rᵢₖ, Fₖₘ) typically relate to mean length deviations from ideal ones of corresponding combinations (Rᵢₖ, Fₖₘ). In step S1630, dynamic write strategy modifications dₙ(Rᵢₖ, Fₖₘ) are calculated according to the measured mean length deviations of corresponding combinations Sₙ(Rᵢₖ, Fₖₘ). For example, corrections for any combinations of (Rᵢₖ, Fₖₘ) can be determined by the following equation:
d(Rᵢₖ, Fₖₘ)=K(Rᵢₖ, Fₖₘ)*S(Rᵢₖ, Fₖₘ),
where d(Rᵢₖ, Fₖₘ) represents a correction for a particular combination of (Rᵢₖ, Fₖₘ), S(Rᵢₖ, Fₖₘ) represents a measured mean length deviations of a particular combination of (Rᵢₖ, Fₖₘ), and K(Rᵢₖ, Fₖₘ) represents a proportionality constant for a particular combination of (Rᵢₖ, Fₖₘ).

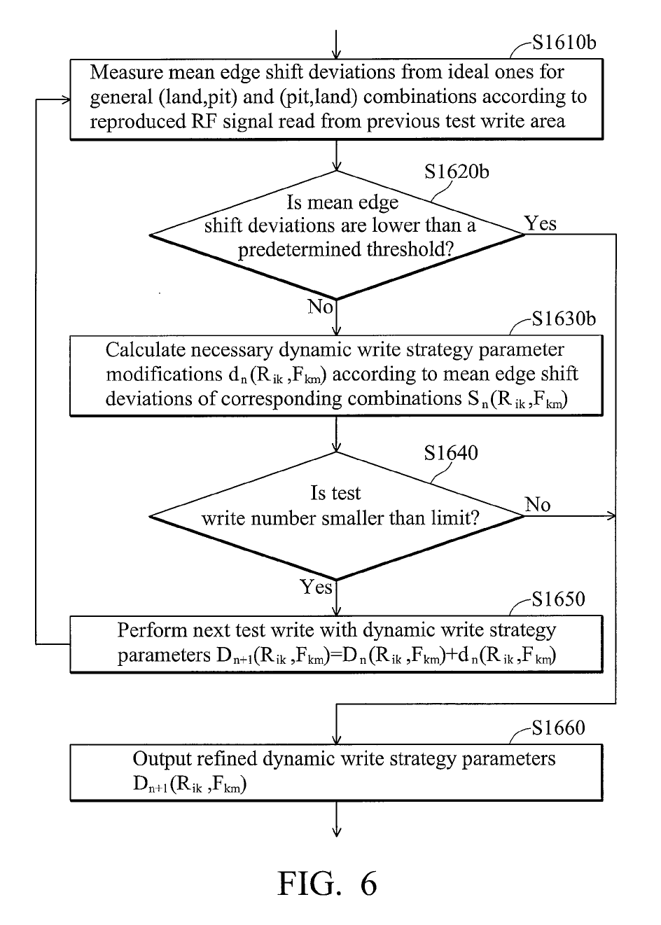

FIG. 6 is a flowchart illustrating a second embodiment of a method for adjusting dynamic write strategy parameters, performed in step S1600 of FIG. 3. The differences from the first embodiment illustrated in FIG. 5 are steps 1610b, 1620b and 1630b. The second embodiment performs adjustments based on mean edge shift deviations (other than mean length deviations as shown in step S1610 of FIG. 5) from ideal ones for general (land,pit) and (pit,land) combinations. Thus, in step S1610b, mean edge shift deviations from ideal ones for general (land,pit) and (pit,land) combinations are measured according to reproduced RF signals read from previous test write area. In step S1620b, it determines whether the measured mean edge shift deviations (other than mean length deviation as shown in step S1620 of FIG. 5) are smaller than a predetermined threshold. In step S1630b, dynamic write strategy modifications dₙ(Rᵢₖ, Fₖₘ) are calculated according to the measured mean edge shift deviation (other than mean length deviation as shown in step S1630 of FIG. 5) of corresponding combinations Sₙ(Rᵢₖ, Fₖₘ).

After calculating dynamic write strategy modifications, step S1640 determines whether test write number (i.e. runs) is smaller than a predetermined test limit. If so, the process proceeds to step S1650, and otherwise, to step S1660. Typically, the predetermined test limit equals one, namely, the dynamic write strategy parameters are often tuned to an acceptable level at one time. In step S1650, the next test writes with dynamic write strategy parameters Dₙ₊₁(Rᵢₖ, Fₖₘ)=Dₙ(Rᵢₖ, Fₖₘ)+dₙ(Rᵢₖ, Fₖₘ) are performed.

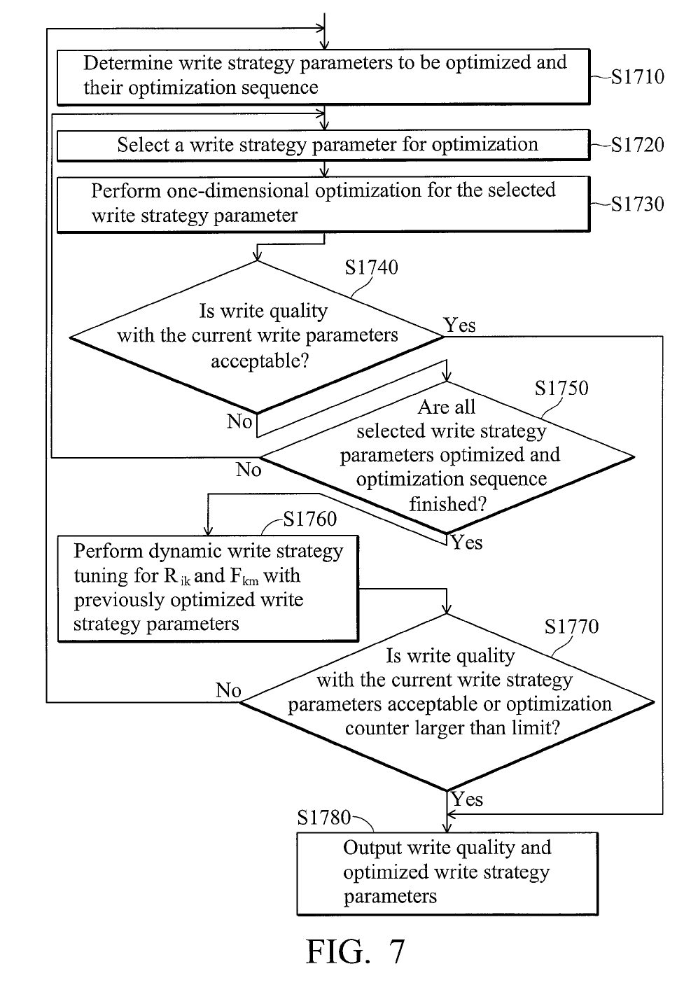

FIG. 7 is a flowchart illustrating an embodiment of a method of full adjustment for all write strategy parameters. These write strategy parameters are divided into two kinds: static and dynamic write strategy parameters. These static write strategy parameters such as P_{w}, OD/m, Eₖ and Sₖ of FIGS. 1a and 1b, relate to pattern lengths and are unaffected from combinations of previous and following patterns (i.e. are not required to be adapted for combinations of previous and following patterns). These dynamic write strategy parameters such as Rᵢₖ and Fₖₘ of FIGS. 1a and 1b, relate to combinations of previous and following T-length patterns, where i, k, m (i.e. T-lengths) may be as 3T to 6T or greater. The optimized static write strategy parameters are obtained by one-dimensional search in steps S1710 to S1750. The optimized dynamic write strategy parameters for combinations of (Rᵢₖ, Fₖₘ) are obtained by calculating corrections and incrementally modifying according to the calculated corrections in step S1760.

In Step S1710, static write strategy parameters to be optimized are selected, such as P_{w}, OD/m, Eₖ or Sₖ or any of the combinations, and simultaneously, in step S1710, an optimization sequence containing the selected static write strategy parameters is determined, such as P_{w}, OD, P_{w}, Eₖ and Sₖ in sequence. The combination of static write strategy parameters typically relate to soft/hard limits provided in steps S1400 and S1500. Different static write strategy parameter combinations match different pairs of hard and soft limits. That is to say, static write strategy parameters to be optimized can be filtered by using different soft/hard limits in order to obtain an effective optimization sequence.

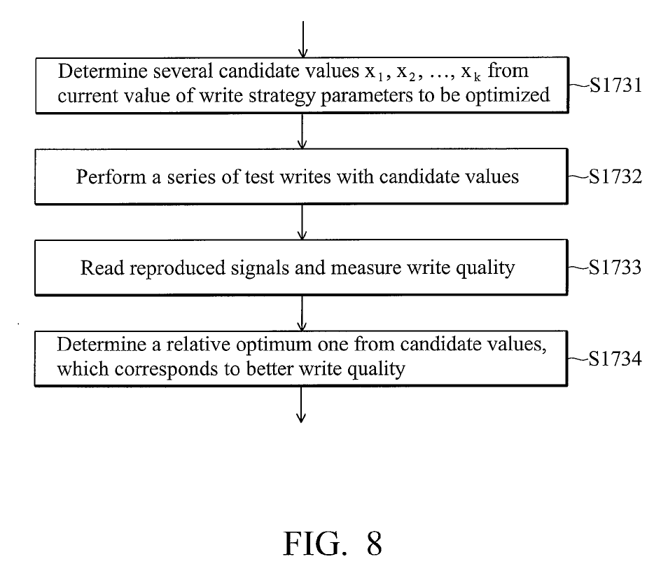

In step S1720, a static write strategy parameter to be optimized is determined according to the determined optimization sequence. FIG. 8 is a flowchart illustrating an embodiment for obtaining an optimized value using one-dimensional search. In step S1731, a series of candidate values X₁ to Xₙ are generated from a current value of the selected static write strategy parameter, where n represents quantity of candidate values. For example, one of candidate values is the base value increased or decreased by a shift value. In step S1732, a series of test writes in a write strategy with previously generated candidate values X₁ to Xₙ of the selected static write strategy parameters, and the remaining fixed static write strategy parameters are performed. In step S1733, RF signals are reproduced from previous test writes to measure write quality of the reproduced signals. In step S1734, the relative optimum candidate value is determined from the previously generated candidate values. In step S1734, it may determine one generated candidate value corresponding to the best write quality index as the best candidate value of the selected static write strategy parameter, or determine an average value of candidate values whose write quality index exceeds a predetermined threshold as the best candidate value of the selected static write strategy parameter. In steps S1732 to S1734, it may measure the write quality indices till all test writes are completely performed, or may measure the write quality indices after a portion of test writes are performed and sequentially measure another portion til all test writes are performed. The write quality index may be RF signal asymmetry 33s, data error rates 34s, jitter magnitudes 35s, mean length deviations for all pattern combinations 36s, and mean edge shift deviations for all pattern combinations 37s output from the write quality detection unit 31 (FIG. 3).

Referring to FIG. 7, in step S1740, it determines whether write quality of the current write strategy parameters is acceptable. If so, the process proceeds to step S1780, otherwise, to step S1750. Step S1740 performs no further test write and obtains write quality indices by measuring a test write area corresponding to the relative optimum value or values. In step S1750, it determines whether all selected write strategy parameters are optimized and the determined optimization sequence is finished. If so, the process proceeds to step S1760 to perform dynamic write strategy parameter adjustment, otherwise, to step S1720.

In step S1760, two embodiments of dynamic write strategy parameter adjustments are described in the above-described FIGS. 6 and 7. The dynamic write strategy modifications are calculated according to the measured mean length deviation or mean edge deviation of corresponding combinations, details of calculation described in the above.

In step S1770, it determines whether write quality of previous test writes with newly obtained write strategy parameters satisfies predetermined target or optimization counter (i.e. runs) exceeds a predetermined limit. If so, the process proceeds to step S1780 to output the measured write quality and optimized write strategy parameters, otherwise, to step S1710 to start the next run of write strategy parameter optimization. Step S1770 performs no further test write and obtains write quality indices by measuring the last test write area performed by the prior step. In practice, after performing only single run of full adjustment for all write strategy parameters, acceptable write quality is acquired. Therefore, excellent write quality could be attained by setting the predetermined limit to one.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for optimizing write strategy parameters by adopting different adjustment procedures according to quality indices, comprising:
acquiring a quality index representing a reproduction result corresponding to a write strategy;
determining one adjustment procedure from a plurality of adjustment procedures according to the acquired quality index; and
performing the determined adjustment procedure to optimize the write strategy,
wherein the write strategy comprises a plurality of write strategy parameters and each adjustment procedure comprises at least one of the write strategy parameters to be adjusted and the sequence of the adjusted write strategy parameters.

2. The method of claim 1 wherein the reproduction result is an asymmetry of a radio frequency (RF) signal, a data error rate, a jitter magnitude, a mean length deviation or a mean edge shift deviation for all pattern combinations.

3. The method of claim 1 wherein the write strategy is a castle-type laser output, the write strategy parameter indicates a laser power level, an over drive (OD), an OD power width of a front end for a nT pattern, an OD power width of a back end for a nT pattern, a position after an ideal prior land for a distance, or a position prior to an ideal subsequent land for a distance for a (land,pit) and (pit,land) combination.

4. The method of claim 1 wherein the write strategy is a multi-pulse laser output, the write strategy parameter indicates a power level, a percentage denoting width of one middle pulse into base clock, a width of a front end for a nT pattern, a width of a back end for a nT pattern, a position after an ideal prior land for a distance, or a position prior to an ideal subsequent land for a distance for a (land,pit) and (pit,land) combination.

5. The method of claim 1, wherein the write strategy parameters are grouped into a plurality of static write strategy parameters and a plurality of dynamic write strategy parameters, the static write strategy parameters correspond to a signal length of a pit on an optical storage medium and the dynamic write strategy parameters are utilized to overcome heat interference for forming the pit, further comprising:
determining whether the quality index satisfies a soft limit and/or does not satisfy a hard limit;
when the quality index satisfies the soft limit and does not satisfy the hard limit, performing a slight adjustment procedure to optimize the dynamic write strategy parameters; and
when the quality index dissatisfies the soft limit, performing a full adjustment procedure to optimize the static and dynamic write strategy parameters,
wherein the hard limit is more restrictive than the soft limit.

6. The method of claim 5 wherein the full adjustment procedure comprises:
determining at least one static write strategy parameter to be adjusted and an optimization sequence comprising the determined static write strategy parameters in sequence according to the acquired quality index;
performing a static optimization procedure to optimize the determined static write strategy parameters along with the determined optimization sequence; and
performing a dynamic optimization procedure to optimize the determined dynamic write strategy parameters after the static optimization procedure is performed.

7. The method of claim 6 wherein the dynamic write strategy parameter optimization procedure is performed when a result of write quality of the write strategy adjusted by the static write strategy parameter optimization procedure is not acceptable.

8. The method of claim 6 wherein the full adjustment procedure is repeatedly performed until that a result of write quality of the write strategy adjusted by the prior full adjustment procedure is acceptable or a value representing adjustment runs of the full adjustment procedures exceeds a predetermined threshold.

9. A system for optimizing write strategy parameters by adopting different adjustment procedures according to quality indices, comprising:
a signal read unit;
a write parameter adjustment unit for acquiring at least one reproduced quality index corresponding to a write strategy from the signal read unit, determining one adjustment procedure according to the reproduced quality index to optimize the write strategy; and
a pattern write unit for outputting the write strategy from the write parameter adjustment unit;
wherein the write strategy comprises a plurality of write strategy parameters and the adjustment procedure comprises at least one of the write strategy parameters to be adjusted and the sequence of the adjusted write strategy parameters.

10. The system of claim 9 wherein the write parameter adjustment unit further comprises a write quality detection unit and a write parameter adjustment controller.

11. The system of claim 10 wherein the write quality detection unit comprises at least one element selected in a group comprised of an asymmetry detector, an error detector, a jitter detector, a length deviation detector and an edge deviation detector.

12. The system of claim 11 wherein the at least one reproduced quality index is selected in a group comprised of an asymmetry of a radio frequency (RF) signal, a data error rate, a jitter magnitude, a mean length deviation or a mean edge shift deviation for all pattern combinations.

13. The system of claim 9 wherein the write strategy is a castle-type laser output, the write strategy parameter indicates a laser power level, an over drive (OD), an OD power width of a front end for a nT pattern, an OD power width of a back end for a nT pattern, a position after an ideal prior land for a distance, or a position prior to an ideal subsequent land for a distance for a (land,pit) and (pit,land) combination.

14. The system of claim 9 wherein the write strategy is a multi-pulse laser output, the write strategy parameter indicates a power level, a percentage denoting width of one middle pulse into base clock, a width of a front end for a nT pattern, a width of a back end for a nT pattern, a position after an ideal prior land for a distance, or a position prior to an ideal subsequent land for a distance for a (land,pit) and (pit,land) combination.

15. The system of claim 14, wherein the write strategy parameters are grouped into a plurality of static write strategy parameters and a plurality of dynamic write strategy parameters, the static write strategy parameters correspond to a signal length of a pit on an optical storage medium, the dynamic write strategy parameters are utilized to overcome heat interference for forming the pit, the write parameter adjustment controller determines whether the quality index satisfies a soft limit and/or dissatisfies a hard limit, performs a slight adjustment procedure to optimize the dynamic write strategy parameters when the quality index satisfies the soft limit and dissatisfies the hard limit, and performs a full adjustment procedure to optimize the static and dynamic write strategy parameters when the quality index does not satisfy the soft limit, and the hard limit is more restrictive than the soft limit.

16. The system of claim 15 wherein the full adjustment procedure comprises:
determining at least one static write strategy parameter to be adjusted and an optimization sequence comprising the determined static write strategy parameters in sequence according to the acquired quality index;
performing a static optimization procedure to optimize the determined static write strategy parameters along with the determined optimization sequence; and
performing a dynamic optimization procedure to optimize the determined dynamic write strategy parameters after the static optimization procedure is performed.

17. The system of claim 16 wherein the dynamic write strategy parameter optimization procedure is performed when a result of write quality of the write strategy adjusted by the static write strategy parameter optimization procedure is not acceptable.

18. The system of claim 16 wherein the full adjustment procedure is repeatedly performed until that a result of write quality of the write strategy adjusted by the prior full adjustment procedure is acceptable or a value representing adjustment runs of the full adjustment procedures exceeds a predetermined threshold.

19. The system of claim 9 wherein the system further comprising a write parameters storage unit for storing the write strategy output by the write parameter adjustment unit.

20. The system of claim 19 wherein the write parameters storage unit is an EPROM or a FLASH-ROM.
